(19) United States
(12) Patent Application Publication
(10) Pub. No.: US 2025/0385527 A1
(43) Pub. Date: Dec. 18, 2025

(54) SOLAR POWER-ASSISTED HYBRID BATTERY BALANCING SYSTEM

(71) Applicant: Kettering University, Flint, MI (US)

(72) Inventors: Chen Duan, Canton, MI (US); Raymond Clark Blair, Jr., Flushing, MI (US); Kenton Thomas Clarke Kyger, Ceresco, MI (US)

(21) Appl. No.: 19/210,518

(22) Filed: May 16, 2025

Related U.S. Application Data
(60) Provisional application No. 63/660,808, filed on Jun. 17, 2024.

(51) Int. Cl. H02J 7/00; H02J 7/34; H02J 7/35

(52) U.S. Cl. CPC H02J 7/0019; H02J 7/0048; H02J 7/0063; H02J 7/342; H02J 7/345; H02J 7/35; H02J 2207/50; H02J 2300/24

(57) ABSTRACT

Systems and methods directed to solar power-assisted hybrid battery balancing are disclosed. For example, operating the solar power-assisted hybrid battery balancing system includes determining accessibility of solar power from a plurality of solar panels and in response to determining solar power is not accessible, activating one or more arrangements of a plurality of switches to enable a battery balancing process including redistribution of stored energy among a plurality of battery cells to maintain a balanced state-of-charge across the plurality of battery cells and transferring of charge between battery cells via a capacitor coupled to output terminals of a solar charge controller. The method includes, in response to determining solar power is accessible, activating one or more other arrangements of the plurality of switches to enable a solar battery balancing process including directing of solar-generated electrical energy among the plurality of battery cells to maintain the balanced state-of-charge.

### CROSS-REFERENCE TO RELATED APPLICATION

This utility application claims the benefit of U.S. Provisional Application No. 63/660,808 filed Jun. 17, 2024, titled “SOLAR POWER-ASSISTED HYBRID BATTERY BALANCING SYSTEM”. The provisional application is incorporated by reference herein as if reproduced in full below.

### FIELD

The following description relates to technology related to energy management systems, specifically a solar-assisted battery management system.

### BACKGROUND

Amid the growing shift towards sustainable energy sources, efficient utilization of solar energy in hybrid power systems is integral. Conventional battery powered systems often struggle with the challenge of uneven charging and discharging of battery cells, leading to reduced battery life and performance inefficiencies. Another challenge faced by battery powered systems is that existing conventional balancing systems waste energy and generate excess heat during operation.

### SUMMARY

This disclosure relates generally to a solar power-assisted hybrid battery balancing system.

An aspect of the disclosed embodiments includes a solar power-assisted hybrid battery balancing system. The solar power-assisted hybrid battery balancing system comprises: a plurality of solar panels configured to convert sunlight into solar-generated electrical energy; a plurality of battery cells configured to store electrical energy; a solar charge controller configured to manage flow of the solar-generated electrical energy between the plurality of solar panels and the plurality of battery cells; a capacitor coupled to output terminals of the solar charge controller; a plurality of switches coupled between the solar charge controller and the plurality of battery cells; and a control circuit coupled to the plurality of switches. The control circuit is configured to: determine accessibility of solar power from the plurality of solar panels; in response to determining solar power is not accessible, activate one or more arrangements of the plurality of switches to enable a battery balancing process including redistribution of stored energy among the plurality of battery cells to maintain a balanced state-of-charge or voltage across the plurality of battery cells; and in response to determining solar power is accessible, activate one or more other arrangements of the plurality of switches to enable a solar battery balancing process including directing of the solar-generated electrical energy among the plurality of battery cells to maintain the balanced state-of-charge or voltage across the plurality of battery cells. The solar charge controller is further configured to adjust an output of the solar-generated electrical energy of the solar charge controller to one or more battery cells of the plurality of battery cells during the solar battery balancing process, and the capacitor is configured to enable the battery balancing process by facilitating the redistribution of stored energy among the plurality of battery cells.

Another aspect of the disclosed embodiments includes a method for operating a solar power-assisted hybrid battery balancing system. The method comprises: determining accessibility of solar power from a plurality of solar panels; in response to determining solar power is accessible, activating one or more arrangements of a plurality of switches to enable a solar battery balancing process including directing of solar-generated electrical energy, via a solar charge controller, among a plurality of battery cells to maintain a balanced state-of-charge or voltage across the plurality of battery cells; and in response to determining solar power is not accessible, activating one or more other arrangements of the plurality of switches to enable a battery balancing process including redistribution of stored energy, via a capacitor coupled to output terminals of the solar charge controller, among the plurality of battery cells to maintain the balanced state-of-charge or voltage across the plurality of battery cells.

Another aspect of the disclosed embodiments includes a solar power-assisted hybrid battery balancing system. The solar power-assisted hybrid battery balancing system comprises: a plurality of solar panels configured to convert sunlight into solar-generated electrical energy; a plurality of battery cells configured to store electrical energy; a solar charge controller configured to manage flow of the solar-generated electrical energy between the plurality of solar panels and the plurality of battery cells; a capacitor coupled to output terminals of the solar charge controller; a plurality of switches coupled between the solar charge controller and the plurality of battery cells; and a control circuit coupled to the plurality of switches. The control circuit is configured to: determine accessibility of solar power from the plurality of solar panels; in response to determining solar power is not accessible, activate one or more arrangements of the plurality of switches to enable a battery balancing process including redistribution of stored energy among the plurality of battery cells to maintain a balanced state-of-charge or voltage across the plurality of battery cells; and in response to determining solar power is accessible, activate one or more other arrangements of the plurality of switches to enable a solar battery balancing process including directing of the solar-generated electrical energy among the plurality of battery cells to maintain the balanced state-of-charge or voltage across the plurality of battery cells. The solar charge controller is further configured to adjust an output of the solar-generated electrical energy of the solar charge controller to one or more battery cells of the plurality of battery cells during the solar battery balancing process. The capacitor is configured to facilitate the redistribution of stored energy among the plurality of battery cells during the battery balancing process and each arrangement of the one or more arrangements and each arrangement of the one or more other arrangements are defined by a state of each switch within the plurality of switches.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a block diagram of a solar power-assisted hybrid battery balancing system, according to the principles of the present disclosure.

FIG. 2 generally illustrates a more detailed representation of a solar power-assisted hybrid battery balancing system, according to the principles of the present disclosure.

FIG. 3 shows tables that generally illustrate statuses of switches during operation of battery balancing system in different balancing modes, according to the principles of the present disclosure.

FIG. 4 depicts a flowchart of an exemplary method for operating a solar power-assisted hybrid battery balancing system, according to an example embodiment.

FIG. 5 depicts a flowchart of another exemplary method for operating a solar power-assisted hybrid battery balancing system, according to an example embodiment.

FIG. 6 is a block diagram of an example computing device that may be used to implement embodiments, according to the principles of the present disclosure.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present disclosure described herein.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present disclosure and accompanying drawings disclose one or more embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

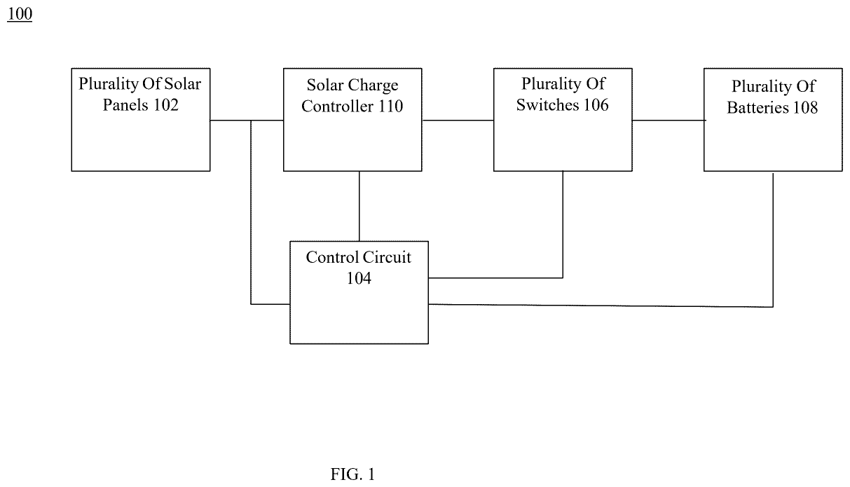

FIG. 1 generally illustrates a block diagram of a solar power-assisted hybrid battery balancing system, also referred to as a battery balancing system herein, according to the principles of the present disclosure. As generally illustrated in FIG. 1, a battery balancing system 100 includes a plurality of solar panels 102, a control circuit 104, a plurality of switches 106, a plurality of battery cells 108, and a solar charge controller 110.

Each solar panel of the plurality of solar panels 102 may be configured to convert sunlight into solar-generated electrical energy. For example, each solar panel of the plurality of solar panels 102 convert sunlight into electricity by using photovoltaic (PV) cells. PV cells are made of materials that produce excited electrons when exposed to light. The electrons flow through a circuit and produce direct current (DC) electricity.

As depicted in FIG. 1, the plurality of switches 106 are coupled between the solar charge controller 110 and the plurality of battery cells 108. The plurality of switches 106 may be arranged to control connectivity between the solar charge controller 110 and the plurality of battery cells 108. In accordance with embodiments disclosed herein, the plurality of switches 106 may include any of the following: mechanical switches, relays, transistors (such as Bipolar Junction Transistors or Field-Effect Transistors), thyristors, solid state relays, or Insulated Gate Bipolar Transistors.

In FIG. 1, the plurality of battery cells 108 may be configured to store the electrical energy generated by a charger or generator (e.g., hybrid car). Additionally, the plurality of battery cells 108 may be balanced or trickle charged by the plurality of solar panels 102.

In FIG. 1, the solar charge controller 110 (e.g., DC/DC converter) is configured to manage flow of solar-generated electrical energy between the plurality of solar panels and the plurality of battery cells.

As further depicted in FIG. 1, the control circuit 104 is coupled to the plurality of switches 106. The control circuit 104 may be configured to activate, based on state-of-charge (SOC) or voltage of each battery cell of the plurality of battery cells 108, individual switches of the plurality of switches 106 to regulate a charging process and maintain a balanced SOC or voltage across the plurality of battery cells 108. SOC, as used herein, (also referred to as charge status herein) quantifies the remaining capacity available in a battery at a given time and may be expressed as a percentage (0%=empty; 100%=full). A balanced SOC or voltage, as used herein, refers to a condition where each battery cell of the plurality of battery cells 108 have substantially similar charge levels.

Additionally, the control circuit 104 may be configured to activate individual switches of the plurality of switches 106 based on prevailing solar conditions. Solar conditions, as used herein, refer to environmental and temporal factors that affect the performance of solar panels in generating electricity. These conditions can include: intensity of sunlight, which is influenced by factors like time of day, season, weather, and geographic location; angle of sunlight, which affects how much light that hits solar panels; temperature, which can affect panel efficiency; and presence of shade or cloud cover, which can block or reduce the intensity of sunlight reaching solar panels.

Additionally, the control circuit 104 may be configured to activate individual switches of the plurality of switches 106 based on current operating state (also referred to as charge state herein) of the plurality of battery cells 108. Operating state, as used herein, refers to whether the plurality of battery cells 108 are actively being charged or are on standby (i.e., ready to be charged or providing power) or whether the plurality of battery cells 108 are in a state of discharge (i.e., supplying power). The control circuit 104 may use the current operating status to determine whether to open or close switches to initiate charging, continue standby mode, or stop discharge.

In some embodiments, a predetermined efficiency threshold at which solar power is considered “not accessible” may be utilized. For instance, if a solar panel output falls below a minimum voltage or current required by the control circuit 104 to initiate the charging process, it could be considered that solar power is not accessible or unavailable.

In some embodiments, a threshold difference of SOC or voltage between battery cells may necessitate balancing between battery cells of the plurality of battery cells 108. For instance, a difference of 5% to 10% in SOC between any two battery cells of the plurality of battery cells 108 could be considered significant enough to require balancing.

To help further illustrate, when SOCs or voltages of plurality of battery cells 108 are unbalanced and solar power is accessible (i.e., the plurality of solar panels 102 are able to generate a usable amount of electricity), the control circuit 104 directs charging towards one or more battery cells of the plurality of batteries cells 108 with the lowest SOC or voltage by engaging the appropriate switches of the plurality of switches 106. Conversely, if SOCs or voltages of the plurality of battery cells 108 are balanced and solar power is accessible but plurality of batteries cells 108 have not reached full capacity, the control circuit 104 may allocate charging to all battery cells of the plurality of battery cells 108 by engaging the appropriate switches. When SOCs or voltages of battery cells of the plurality of battery cells 108 are unbalanced, solar power is not accessible (such as during night-time or under indoor conditions), and the plurality of battery cells 108 is either being charged and/or is in standby mode, the control circuit 104 may initiate an active balancing process between battery cells of the plurality of battery cells 108. This process may involve redistributing energy from battery cells with higher charge levels to those with lower charge levels, ensuring an even state of charge across the plurality of battery cells 108.

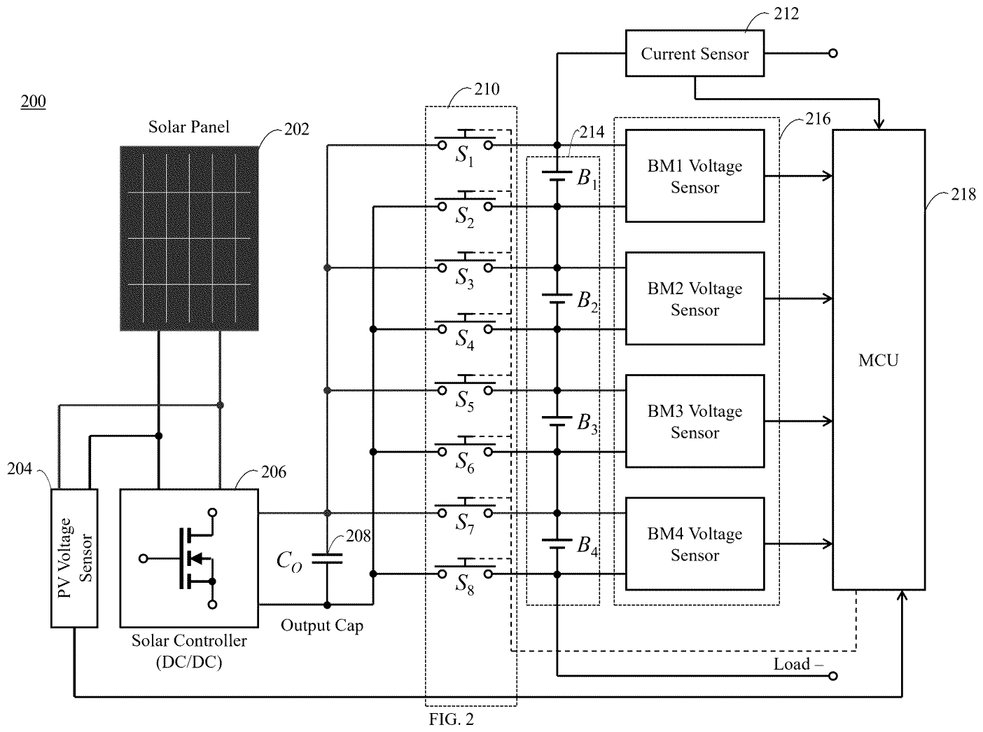

FIG. 2 generally illustrates a more detailed representation of a solar power-assisted hybrid battery balancing system, according to the principles of the present disclosure. As shown in FIG. 2, battery balancing system 200 includes a solar panel 202, a PV voltage sensor 204, a solar charge controller 206, an output capacitor 208, a plurality of switches 210, a current sensor 212, a plurality of battery cells 214, a plurality of voltage sensors 216, and a main control unit (MCU) 218.

The solar charge controller 206 is an example embodiment of the solar charge controller 110 in FIG. 1, and the MCU 218 is an example embodiment of the control circuit 104 in FIG. 1. In some embodiments, the control circuit 104 and the solar charge controller 110 in FIG. 1 may include a variety of configurations and components depending on the complexity and requirements of the battery balancing system. In some embodiments, the battery balancing system 200 may include any number of solar panels or battery cells depending on required capacity and energy demands.

In FIG. 2, the solar charge controller 206 may be configured to regulate the power coming from the solar panel 202 to the plurality of battery cells 214. For example, the solar charge controller 206 may step up or down the voltage to appropriate levels for battery charging. This ensures that the plurality of battery cells 214 charge at the correct voltage and current levels, which prevents overcharging, which can reduce battery lifespan, and undercharging, which can affect the performance of the battery balancing system 200. As also shown in FIG. 2, the output capacitor 208 is connected to output terminals of the solar charge controller 206 and may be sized for redistribution of stored energy among the plurality of battery cells 214.

In FIG. 2, the plurality of switches 210 includes switches S1, S2, S3, S4, S5, S6, S7, and S8, and the plurality of battery cells 214 includes battery cells B1, B2, B3, and B4 connected in series. As depicted in FIG. 2, switches S1, S3, S5, and S7 link positive terminals of each battery cell of the plurality of battery cells 214 to a positive output terminal of the solar charge controller 206, and switches S2, S4, S6, and S8 link negative terminals of each battery cell of the plurality of battery cells 214 to a negative output terminal of the solar charge controller 206. In other embodiments, the plurality of battery cells 214 may comprise other configurations of battery cells, such as any configuration of battery cells in series.

In FIG. 2, the PV voltage sensor 204 may be configured to measure voltage output from the solar panel 202. The voltage output may be used to monitor performance of the solar panel 202, and thereby, used to monitor prevailing solar conditions. Also, in FIG. 2, the plurality of voltage sensors 216 include BM1, BM2, BM3, and BM4 voltage sensors, and BM1, BM2, BM3, and BM4 voltage sensors may be configured to measure voltage output of respective battery cells, B1, B2, B3, and B4, and thereby, used to monitor SOC or voltage of each battery cell of the plurality of battery cells 214. Further, in FIG. 2, the current sensor 212 may be configured to measure an amount of electric current flowing to a load or to the plurality of battery cells 214 and used to monitor SOC or voltage of the plurality of battery cells 214 and battery status (e.g., charge, discharge, standby, etc.).

Still yet, in FIG. 2, the MCU 218 is coupled to the plurality of switches 210 and configured to activate, based on inputs from the PV voltage sensor 204, the plurality of voltage sensors 216, and/or the current sensor 212, individual switches of the plurality of switches 210 to regulate a charging process of the plurality of battery cells 214 and maintain a balanced SOC or voltage across the plurality of battery cells 214.

For example, the MCU 218 may continuously monitor signals from sensors: the PV voltage sensor 204, the current sensor 212, and the plurality of voltage sensors 216. For example, based on interpretation of the receive signals by the MCU 218, if solar power is accessible and a particular battery cell of the plurality of battery cells 214 falls below a predetermined threshold (or there is a threshold difference of SOC or voltage between two battery cells of the plurality of battery cells 214), indicating a lower SOC or voltage compared to other battery cells, then the MCU 218 may activate one or more switches corresponding to that particular battery cell (e.g., to charge battery cell B1, S1 and S2 may be closed).

As another example, if SOCs or voltages of the plurality of battery cells 214 are balanced and solar power is accessible but the plurality of batteries cells 214 are not fully charged, the MCU 218 may activate one or more switches of the plurality of switches 210 to allocate charging to all battery cells of the plurality of battery cells 214 (e.g., by closing switches S1 and S8). For example, switches S1 and S8 are used as the positive and negative terminals for the entire the plurality of battery cells 214.

Still yet, as another example, when SOCs or voltages of battery cells of the plurality of battery cells 214 are unbalanced, solar power is not accessible, and the plurality of battery cells 214 are either being charged and/or in standby mode, the MCU 218 may activate one or more switches of the plurality of switches 210 to balance battery cells of the plurality of battery cells 214 and use the output capacitor 208 as a storage element to facilitate transfer of charge between battery cells of the plurality of battery cells 214. For instance, to charge battery cell B4 from battery cell B1, the MCU 218 may close switches S1 and S2 to charge the output capacitor 208. When the output capacitor 208 is fully charged, switches S1 and S2 are opened, while switches S7 and S8 are closed, allowing the output capacitor to charge battery cell B4. The process may repeat until all battery cells of the plurality of battery cells 214 are balanced or the battery balancing system 200 enters another operating condition.

In some embodiments, an operating mode of the battery balancing system 200 is determined using the PV voltage sensor 204. Once the voltage reaches a threshold determined by the needs of the battery balancing system 200, the MCU 218 determines that solar energy is accessible and can be used to charge battery cells of the plurality of battery cells 214.

In some embodiments, if solar energy is not available or insufficient, then charge status of the plurality of battery cells 214 may be determined using the current sensor 212. During discharge, the MCU 218 may deactivate all switches of the plurality of switches 210 to reduce power consumption. In some embodiments, if charging or standby is detected, then the SOCs or voltages of battery cells of the plurality of battery cells 214 are measured to determine if active balancing is needed. Unbalanced battery cells of the plurality of battery cells 214 will go through active balancing, which may be performed by comparing the voltages and storing the highest and lowest voltage battery cell numbers. The MCU 218 may close switches corresponding to the highest voltage battery cell to begin the charging of the output capacitor 208. After a predetermined charging time, the output capacitor 208 may be disconnected and then connected to lowest voltage battery cell of the plurality of battery cells 214. After a predetermined discharging time, the output capacitor 208 is disconnected. This process continues if solar energy is unavailable, the plurality of battery cells 214 are charging and/or in standby, and battery cells of the plurality of battery cells 214 are unbalanced. If the battery cells are balanced, the output capacitor 208 is not connected to any battery cells of the plurality of battery cells 214 until the battery cells become unbalanced; this may reduce energy loss.

In some embodiments, if solar energy is available and sufficient, the MCU 218 may determine charge status of battery cells of the plurality of battery cells 214 to see if charging is required based on the plurality of voltage sensors 216. If the plurality of battery cells 214 are fully charged, the MCU 218 may not use the available solar energy. However, if the plurality of battery cells 214 are not fully charged, voltages of each battery cell of the plurality of battery cells 214 will be checked for their current balanced status. Unbalanced battery cells will undergo solar balancing, which happens when the variance between the battery cells is greater than a set threshold. The MCU 218 routes available solar energy to the lowest charged battery cell by activating or deactivating particular switches of the plurality of switches 210. Balanced battery cells undergo solar charging. The MCU 218 activates particular switches of the plurality of switches 210 to put the output capacitor 208 in parallel with the plurality of battery cells 214 to charge all battery cells at once.

In some embodiments, the MCU 218 is configured to determine accessibility of solar power from plurality of the solar panels 202 and in response to determining solar power is not accessible, activate one or more arrangements of the plurality of switches 210 to enable a battery balancing process including redistribution of stored energy among the plurality of battery cells 214 to maintain a balanced state-of-charge across the plurality of battery cells 214. Additionally, in some embodiments, in response to determining solar power is accessible, the MCU 218 is configured to activate one or more other arrangements of the plurality of switches 210 to enable a solar battery balancing process including directing of the solar-generated electrical energy among the plurality of battery cells 214 to maintain the balanced state-of-charge across the plurality of battery cells 214. In some embodiments, the MCU 218 may be configured to activate the one or more arrangements of the plurality of switches based on an operating state of the plurality of battery cells. In some embodiments, the MCU 218 may be configured to activate the one or more arrangements of the plurality of switches based on a state-of-charge of the plurality of battery cells. Each arrangement of the one or more arrangements and each arrangement of the one or more other arrangements may be defined by a state of each switch within the plurality of switches.

In some embodiments, the solar charge controller 206 is configured to adjust an output of solar-generated electrical energy of the solar charge controller 206 to one or more battery cells of the plurality of battery cells 214 during the solar battery balancing process.

In some embodiments, the output capacitor 208 may include an Aluminum Electrolytic Capacitor. Aluminum Electrolytic Capacitors have the property of higher voltage ranges and are used in low-frequency applications such as in the DC domain, which operates at 0 Hz. The output capacitor 208 is not restricted to any specific type of capacitor; other types of capacitors may be used based on the needs of the battery balancing system 200.

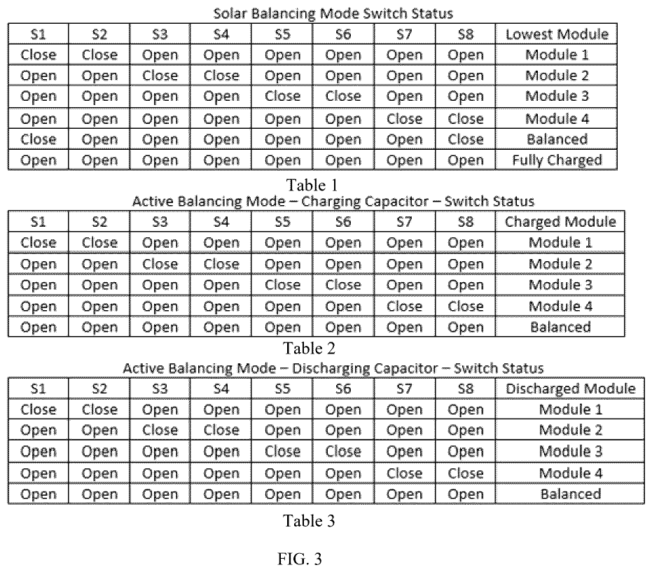

FIG. 3 shows tables that generally illustrate statuses of switches of the plurality of switches 210 (e.g., S1 to S8) during operation of the battery balancing system 200 in different balancing modes. For example, Table 1, “Solar Balancing Mode Switch Status,” indicates the open or closed status of each switch during solar balancing. Each row corresponds to a specific scenario indicating which battery cells or modules (e.g., BM1, BM2, BM3, and BM4) are currently being charged or if the plurality of battery cells 214 are balanced or fully charged. The open or closed statues of each switch facilitates the appropriate charging path to balance the battery cells using solar power.

Table 2, “Active Balancing Mode—Charging Capacitor Switch Status,” depicts the switch status for active balancing when the battery balancing system 200 is charging the output capacitor 208. In this mode, charge is being transferred from output capacitor 208 to a battery cell that needs charging. Similarly, each row indicates which battery cell is being charged.

Table 3, “Active Balancing Mode-Discharging Capacitor Switch Status,” depicts the switch status when discharging the output capacitor 208. In this mode, charge is transferred from a charged battery cell to the output capacitor 208.

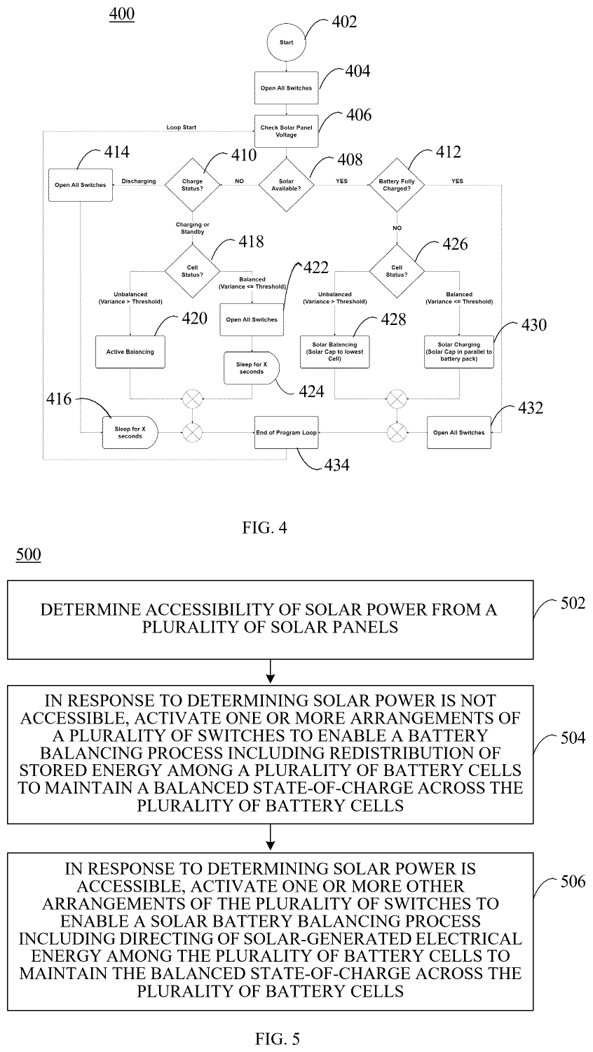

To explore this in further detail, FIG. 4 is described. FIG. 4 depicts a flowchart 400 of a method for operating a battery balancing system, according to an example embodiment. Each step in the flowchart 400 may be performed by the MCU 218. As shown in FIG. 4, the method of the flowchart 400 begins at step 402.

At step 404 in the flowchart 400, all switches of the battery balancing system are opened.

At step 406 in the flowchart 400, solar panel voltage check is performed.

At step 408 in the flowchart 400, it is determined if solar power is available.

At step 410 in the flowchart 400, if solar power is not available, the charge status (e.g., discharging, charging, or standby) of plurality of battery cells is checked.

At step 412 in the flowchart 400, if solar power is available, the battery status (e.g., fully charged or not fully charged) of plurality of battery cells are checked.

At step 414 in the flowchart 400, from step 410, if battery cells are discharging, then all switches are opened.

At step 416 in the flowchart 400, from step 414, battery balancing system sleeps.

At step 418 in the flowchart 400, from step 410, if battery cells are charging or standby, the cell status (e.g., unbalanced or balanced) of each battery cell of the plurality of battery cells are checked.

At step 420 in the flowchart 400, from step 418, if battery cells are unbalanced (e.g., variance>threshold), active balancing begins.

At step 422 in the flowchart 400, from step 418, if battery cells are balanced (e.g., variance<=threshold), all switches are opened.

At step 424 in the flowchart 400, from step 422, battery balancing system sleeps.

At step 426 in the flowchart 400, from step 412, if battery cells are not fully charged, the cell status (e.g., unbalanced or balanced) of each battery cell of the plurality of battery cells are checked.

At step 428 in the flowchart 400, from step 426, if battery cells are unbalanced (e.g., variance>threshold), solar balancing is performed (e.g., output capacitor is used to charge lowest charged battery cell).

At step 430 in the flowchart 400, from step 426, if battery cells are balanced (e.g., variance<=threshold), solar charging is performed (e.g., solar capacitor in parallel to battery pack or plurality of battery cells).

At step 432 in the flowchart 400, from step 412, if battery cells are fully charged, then all switches are opened.

At step 434 in the flowchart 400, the program ends.

To explore this in further detail, FIG. 5 is described. FIG. 5 depicts a flowchart 500 of a method for operating a solar power-assisted hybrid battery balancing system, according to an example embodiment. As shown in FIG. 5, the method of the flowchart 500 begins at step 502. In step 502, accessibility of solar power from a plurality of solar panels is determined.

At step 504 in the flowchart 500, one or more arrangements of a plurality of switches are activated to enable a battery balancing process including redistribution of stored energy among a plurality of battery cells to maintain a balanced state-of-charge across the plurality of battery cells in response to determining solar power is not accessible.

At step 506 in the flowchart 500, one or more other arrangements of the plurality of switches to enable a solar battery balancing process including directing of solar-generated electrical energy among the plurality of battery cells to maintain the balanced state-of-charge across the plurality of battery cells in response to determining solar power is accessible.

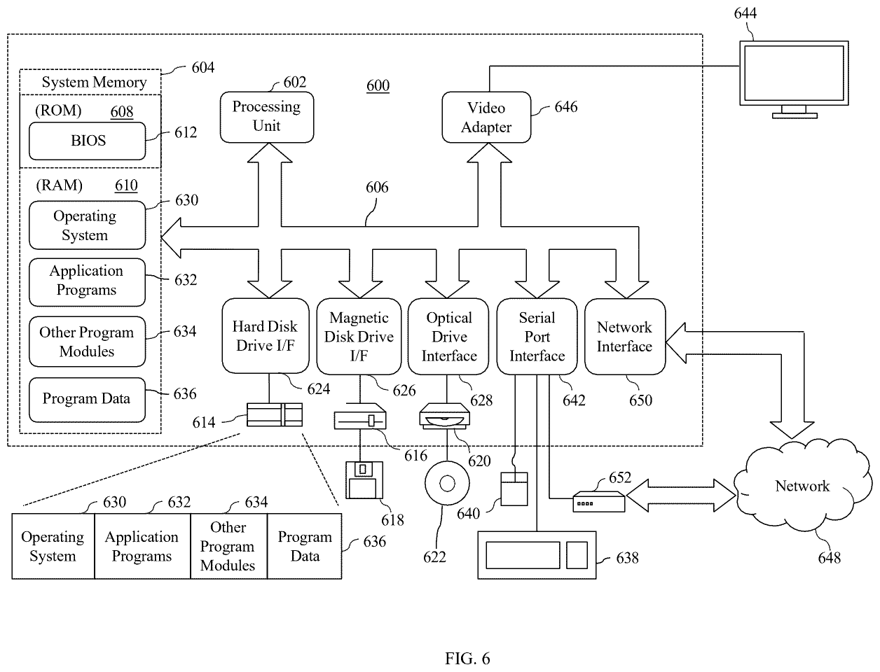

FIG. 6 depicts an example processor-based computer system 600 that may be used to implement various embodiments described herein, such as any of the embodiments described in the above and in reference to FIGS. 1-5. For example, the processor-based computer system 600 may be used to implement any of the components of the battery balancing system 100 in FIG. 1 and the battery balancing system 200 in FIG. 2, as described above in reference to FIGS. 1-5. The description of the processor-based computer system 600 provided herein is provided for purposes of illustration and is not intended to be limiting. Embodiments may be implemented in further types of computer systems, as would be known to persons skilled in the relevant art(s).

As shown in FIG. 6, the processor-based computer system 600 includes one or more processors, referred to as processor circuit 602, a system memory 604, and a bus 606 that couples various system components including the system memory 604 to the processor circuit 602. The processor circuit 602 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. The processor circuit 602 may execute program code stored in a computer readable medium, such as program code of operating system 630, application programs 632, other programs 634, etc. The bus 606 represents one or more of any of several types of bus structures, including a memory bus or memory controller, a peripheral bus, an accelerated graphics port, and a processor or local bus using any of a variety of bus architectures. The system memory 604 includes read only memory (ROM) 608 and random access memory (RAM) 610. A basic input/output system 612 (BIOS) is stored in the ROM 608.

The processor-based computer system 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. The hard disk drive 614, the magnetic disk drive 616, and the optical disk drive 620 are connected to the bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMS, ROMs, and other hardware storage media.

A number of program modules may be stored on the hard disk, magnetic disk, optical disk, ROM, or RAM. These programs include the operating system 630, the one or more application programs 632, the other programs 634, and program data 636. The application programs 632 or the other programs 634 may include, for example, computer program logic (e.g., computer program code or instructions) for implementing the systems described above, including the embodiments described in reference to FIGS. 1-5.

A user may enter commands and information into the processor-based computer system 600 through input devices such as keyboard 638 and pointing device 640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to the processor circuit 602 through a serial port interface 642 that is coupled to the bus 606, but may be connected by other interfaces, such as a parallel port, game port, or a universal serial bus (USB).

A display screen 644 is also connected to the bus 606 via an interface, such as a video adapter 646. The display screen 644 may be external to, or incorporated in the processor-based computer system 600. The display screen 644 may display information, as well as being a user interface for receiving user commands and/or other information (e.g., by touch, finger gestures, virtual keyboard, etc.). In addition to the display screen 644, the processor-based computer system 600 may include other peripheral output devices (not shown) such as speakers and printers.

The processor-based computer system 600 is connected to a network 648 (e.g., the Internet) through an adaptor or network interface 650, a modem 652, or other means for establishing communications over the network. The modem 652, which may be internal or external, may be connected to the bus 606 via the serial port interface 642, as shown in FIG. 6, or may be connected to the bus 606 using another interface type, including a parallel interface.

As used herein, the terms “computer program medium,” “computer-readable medium,” and “computer-readable storage medium” are used to generally refer to physical hardware media such as the hard disk associated with the hard disk drive 614, the removable magnetic disk 618, the removable optical disk 622, other physical hardware media such as RAMs, ROMs, flash memory cards, digital video disks, zip disks, MEMs, nanotechnology-based storage devices, and further types of physical/tangible hardware storage media (including the system memory 604 of FIG. 6). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including the application programs 632 and the other programs 634) may be stored on the hard disk, magnetic disk, optical disk, ROM, RAM, or other hardware storage medium. Such computer programs may also be received via the network interface 650, the serial port interface 642, or any other interface type. Such computer programs, when executed or loaded by an application, enable the processor-based computer system 600 to implement features of embodiments discussed herein. Accordingly, such computer programs represent controllers of the processor-based computer system 600.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

A solar power-assisted hybrid battery balancing system, comprises: a plurality of solar panels configured to convert sunlight into solar-generated electrical energy; a plurality of battery cells configured to store electrical energy; a solar charge controller configured to manage flow of the solar-generated electrical energy between the plurality of solar panels and the plurality of battery cells; a capacitor coupled to output terminals of the solar charge controller and is configured to work as an output filter and perform active balancing energy redistribution; a plurality of switches coupled between the solar charge controller and the plurality of battery cells; and a control circuit coupled to the plurality of switches, the control circuit being configured to: determine accessibility of solar power from the plurality of solar panels; in response to determining solar power is not accessible, activate one or more arrangements of the plurality of switches to enable a battery balancing process including redistribution of stored energy among the plurality of battery cells to maintain a balanced state-of-charge or voltage across the plurality of battery cells; and in response to determining solar power is accessible, activate one or more other arrangements of the plurality of switches to enable a solar battery balancing process including directing of the solar-generated electrical energy among the plurality of battery cells to maintain the balanced state-of-charge or voltage across the plurality of battery cells; wherein the solar charge controller is further configured to adjust an output of the solar-generated electrical energy of the solar charge controller to one or more battery cells of the plurality of battery cells during the solar battery balancing process, and wherein the capacitor is configured to enable the battery balancing process by facilitating the redistribution of stored energy among the plurality of battery cells.

In the solar power-assisted hybrid battery balancing system referenced above, for example in paragraph [0082], the control circuit is further configured to: activate the one or more arrangements of the plurality of switches based on an operating state of the plurality of battery cells.

In the solar power-assisted hybrid battery balancing system referenced above, for example in paragraph [0082], the control circuit is further configured to: activate the one or more arrangements of the plurality of switches based on a state-of-charge or voltage of the plurality of battery cells.

In the solar power-assisted hybrid battery balancing system referenced above, for example in paragraph [0082], the control circuit is further configured to: determine a value of difference of a state-of-charge or voltage between a battery cell and remaining battery cells of the plurality of battery cells; activate a first arrangement of switches of the plurality of switches to charge the capacitor from a highest charged battery cell of the plurality of battery cells; and activate a second arrangement of switches of the plurality of switches to charge the battery cell from the capacitor.

In the solar power-assisted hybrid battery balancing system referenced above, for example in paragraph [0085], the value of difference of the state-of-charge or voltage between the battery cell and the remaining battery cells of the plurality of battery cells is higher than a threshold difference permitted between battery cells of the plurality of battery cells.

In the solar power-assisted hybrid battery balancing system referenced above, for example in paragraph [0082], the control circuit is further configured to: detect the accessibility of solar power by determining if an output of the plurality of solar panels falls below a minimum voltage or current threshold.

In the solar power-assisted hybrid battery balancing system referenced above, for example in paragraph [0082], each arrangement of the one or more arrangements and each arrangement of the one or more other arrangements are defined by a state of each switch within the plurality of switches.

A method for operating a solar power-assisted hybrid battery balancing system, the method comprises: determining accessibility of solar power from a plurality of solar panels; in response to determining solar power is accessible, activating one or more arrangements of a plurality of switches to enable a solar battery balancing process including directing of solar-generated electrical energy, via a solar charge controller, among a plurality of battery cells to maintain a balanced state-of-charge or voltage across the plurality of battery cells; and in response to determining solar power is not accessible, activating one or more other arrangements of the plurality of switches to enable a battery balancing process including redistribution of stored energy, via a capacitor coupled to output terminals of the solar charge controller, among the plurality of battery cells to maintain the balanced state-of-charge or voltage across the plurality of battery cells.

The method referenced above, for example in paragraph [0089], further comprises: activating the one or more arrangements of the plurality of switches based on an operating state of the plurality of battery cells.

The method referenced above, for example in paragraph [0089], further comprises: activating the one or more arrangements of the plurality of switches based on a state-of-charge or voltage of the plurality of battery cells.

The method referenced above, for example in paragraph [0089], further comprises: adjusting an output of the solar-generated electrical energy of the solar charge controller to one or more battery cells of the plurality of battery cells during the solar battery balancing process; and transferring of charge between battery cells of the plurality of battery cells, via the capacitor, during the battery balancing process.

The method referenced above, for example in paragraph [0089], each arrangement of the one or more arrangements and each arrangement of the one or more other arrangements are defined by a state of each switch within the plurality of switches.

The method referenced above, for example in paragraph [0089], further comprises: determining a value of difference of a state-of-charge or voltage between a battery cell and remaining battery cells of the plurality of battery cells; activating a first arrangement of switches of the plurality of switches to charge the capacitor from a highest charged battery cell of the plurality of battery cells; and activating a second arrangement of switches of the plurality of switches to charge the battery cell from the capacitor.

The method referenced above, for example in paragraph [0094], the value of difference of the state-of-charge or voltage between the battery cell and the remaining battery cells of the plurality of battery cells is higher than a threshold difference permitted between battery cells of the plurality of battery cells.

The method referenced above, for example in paragraph [0089], further comprises: detecting the accessibility of solar power by determining if an output of the plurality of solar panels falls below a minimum voltage or current threshold.

A solar power-assisted hybrid battery balancing system, comprises: a plurality of solar panels configured to convert sunlight into solar-generated electrical energy; a plurality of battery cells configured to store electrical energy; a solar charge controller configured to manage flow of the solar-generated electrical energy between the plurality of solar panels and the plurality of battery cells; a capacitor coupled to output terminals of the solar charge controller; a plurality of switches coupled between the solar charge controller and the plurality of battery cells; and a control circuit coupled to the plurality of switches, the control circuit being configured to: determine accessibility of solar power from the plurality of solar panels; in response to determining solar power is not accessible, activate one or more arrangements of the plurality of switches to enable a battery balancing process including redistribution of stored energy among the plurality of battery cells to maintain a balanced state-of-charge or voltage across the plurality of battery cells; and in response to determining solar power is accessible, activate one or more other arrangements of the plurality of switches to enable a solar battery balancing process including directing of the solar-generated electrical energy among the plurality of battery cells to maintain the balanced state-of-charge or voltage across the plurality of battery cells; wherein the solar charge controller is further configured to adjust an output of the solar-generated electrical energy of the solar charge controller to one or more battery cells of the plurality of battery cells during the solar battery balancing process, wherein the capacitor is configured to facilitate the redistribution of stored energy among the plurality of battery cells during the battery balancing process, and wherein each arrangement of the one or more arrangements and each arrangement of the one or more other arrangements are defined by a state of each switch within the plurality of switches.

In the solar power-assisted hybrid battery balancing system referenced above, for example in paragraph [0097], the control circuit is further configured to: activate the one or more arrangements of the plurality of switches based on an operating state of the plurality of battery cells.

In the solar power-assisted hybrid battery balancing system referenced above, for example in paragraph [0097], the control circuit is further configured to: activate the one or more arrangements of the plurality of switches based on a state-of-charge or voltage of the plurality of battery cells.

In the solar power-assisted hybrid battery balancing system referenced above, for example in paragraph [0097], the control circuit is further configured to: determine a value of difference of a state-of-charge or voltage between a battery cell and remaining battery cells of the plurality of battery cells; activate a first arrangement of switches of the plurality of switches to charge the capacitor from a highest charged battery cell of the plurality of battery cells; and activate a second arrangement of switches of the plurality of switches to charge the battery cell from the capacitor.

In the solar power-assisted hybrid battery balancing system referenced above, for example in paragraph [0100], the value of difference of the state-of-charge or voltage between the battery cell and the remaining battery cells of the plurality of battery cells is higher than a threshold difference permitted between battery cells of the plurality of battery cells.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A solar power-assisted hybrid battery balancing system, comprising:
a plurality of solar panels configured to convert sunlight into solar-generated electrical energy;
a plurality of battery cells configured to store electrical energy;
a solar charge controller configured to manage flow of the solar-generated electrical energy between the plurality of solar panels and the plurality of battery cells;
a capacitor coupled to output terminals of the solar charge controller and is configured to work as an output filter and perform active balancing energy redistribution;
a plurality of switches coupled between the solar charge controller and the plurality of battery cells; and
a control circuit coupled to the plurality of switches, the control circuit being configured to:
determine accessibility of solar power from the plurality of solar panels;
in response to determining solar power is not accessible, activate one or more arrangements of the plurality of switches to enable a battery balancing process including redistribution of stored energy among the plurality of battery cells to maintain a balanced state-of-charge or voltage across the plurality of battery cells; and
in response to determining solar power is accessible, activate one or more other arrangements of the plurality of switches to enable a solar battery balancing process including directing of the solar-generated electrical energy among the plurality of battery cells to maintain the balanced state-of-charge or voltage across the plurality of battery cells;
wherein the solar charge controller is further configured to adjust an output of the solar-generated electrical energy of the solar charge controller to one or more battery cells of the plurality of battery cells during the solar battery balancing process, and wherein the capacitor is configured to enable the battery balancing process by facilitating the redistribution of stored energy among the plurality of battery cells.

2. The solar power-assisted hybrid battery balancing system of claim 1, wherein the control circuit is further configured to:
activate the one or more arrangements of the plurality of switches based on an operating state of the plurality of battery cells.

3. The solar power-assisted hybrid battery balancing system of claim 1, wherein the control circuit is further configured to:
activate the one or more arrangements of the plurality of switches based on a state-of-charge or voltage of the plurality of battery cells.

4. The solar power-assisted hybrid battery balancing system of claim 1, wherein the control circuit is further configured to:
determine a value of difference of a state-of-charge or voltage between a battery cell and remaining battery cells of the plurality of battery cells;
activate a first arrangement of switches of the plurality of switches to charge the capacitor from a highest charged battery cell of the plurality of battery cells; and
activate a second arrangement of switches of the plurality of switches to charge the battery cell from the capacitor.

5. The solar power-assisted hybrid battery balancing system of claim 4, wherein the value of difference of the state-of-charge or voltage between the battery cell and the remaining battery cells of the plurality of battery cells is higher than a threshold difference permitted between battery cells of the plurality of battery cells.

6. The solar power-assisted hybrid battery balancing system of claim 1, wherein the control circuit is further configured to:
detect the accessibility of solar power by determining if an output of the plurality of solar panels falls below a minimum voltage or current threshold.

7. The solar power-assisted hybrid battery balancing system of claim 1, wherein each arrangement of the one or more arrangements and each arrangement of the one or more other arrangements are defined by a state of each switch within the plurality of switches.

8. A method for operating a solar power-assisted hybrid battery balancing system, the method comprising:
determining accessibility of solar power from a plurality of solar panels;
in response to determining solar power is accessible, activating one or more arrangements of a plurality of switches to enable a solar battery balancing process including directing of solar-generated electrical energy, via a solar charge controller, among a plurality of battery cells to maintain a balanced state-of-charge or voltage across the plurality of battery cells; and
in response to determining solar power is not accessible, activating one or more other arrangements of the plurality of switches to enable a battery balancing process including redistribution of stored energy, via a capacitor coupled to output terminals of the solar charge controller, among the plurality of battery cells to maintain the balanced state-of-charge or voltage across the plurality of battery cells.

9. The method of claim 8, further comprising:
activating the one or more arrangements of the plurality of switches based on an operating state of the plurality of battery cells.

10. The method of claim 8, further comprising:
activating the one or more arrangements of the plurality of switches based on a state-of-charge or voltage of the plurality of battery cells.

11. The method of claim 8, further comprising:
adjusting an output of the solar-generated electrical energy of the solar charge controller to one or more battery cells of the plurality of battery cells during the solar battery balancing process; and
transferring of charge between battery cells of the plurality of battery cells, via the capacitor, during the battery balancing process.

12. The method of claim 8, wherein each arrangement of the one or more arrangements and each arrangement of the one or more other arrangements are defined by a state of each switch within the plurality of switches.

13. The method of claim 8, further comprising:
determining a value of difference of a state-of-charge or voltage between a battery cell and remaining battery cells of the plurality of battery cells;
activating a first arrangement of switches of the plurality of switches to charge the capacitor from a highest charged battery cell of the plurality of battery cells; and
activating a second arrangement of switches of the plurality of switches to charge the battery cell from the capacitor.

14. The method of claim 13, wherein the value of difference of the state-of-charge or voltage between the battery cell and the remaining battery cells of the plurality of battery cells is higher than a threshold difference permitted between battery cells of the plurality of battery cells.

15. The method of claim 8, further comprising:
detecting the accessibility of solar power by determining if an output of the plurality of solar panels falls below a minimum voltage or current threshold.

16. A solar power-assisted hybrid battery balancing system, comprising:
a plurality of solar panels configured to convert sunlight into solar-generated electrical energy;
a plurality of battery cells configured to store electrical energy;
a solar charge controller configured to manage flow of the solar-generated electrical energy between the plurality of solar panels and the plurality of battery cells;
a capacitor coupled to output terminals of the solar charge controller;
a plurality of switches coupled between the solar charge controller and the plurality of battery cells; and
a control circuit coupled to the plurality of switches, the control circuit being configured to:
determine accessibility of solar power from the plurality of solar panels;
in response to determining solar power is not accessible, activate one or more arrangements of the plurality of switches to enable a battery balancing process including redistribution of stored energy among the plurality of battery cells to maintain a balanced state-of-charge or voltage across the plurality of battery cells; and
in response to determining solar power is accessible, activate one or more other arrangements of the plurality of switches to enable a solar battery balancing process including directing of the solar-generated electrical energy among the plurality of battery cells to maintain the balanced state-of-charge or voltage across the plurality of battery cells;
wherein the solar charge controller is further configured to adjust an output of the solar-generated electrical energy of the solar charge controller to one or more battery cells of the plurality of battery cells during the solar battery balancing process, wherein the capacitor is configured to facilitate the redistribution of stored energy among the plurality of battery cells during the battery balancing process, and wherein each arrangement of the one or more arrangements and each arrangement of the one or more other arrangements are defined by a state of each switch within the plurality of switches.

17. The solar power-assisted hybrid battery balancing system of claim 16, wherein the control circuit is further configured to:
activate the one or more arrangements of the plurality of switches based on an operating state of the plurality of battery cells.

18. The solar power-assisted hybrid battery balancing system of claim 16, wherein the control circuit is further configured to:
activate the one or more arrangements of the plurality of switches based on a state-of-charge or voltage of the plurality of battery cells.

19. The solar power-assisted hybrid battery balancing system of claim 16, wherein the control circuit is further configured to:
determine a value of difference of a state-of-charge or voltage between a battery cell and remaining battery cells of the plurality of battery cells;
activate a first arrangement of switches of the plurality of switches to charge the capacitor from a highest charged battery cell of the plurality of battery cells; and
activate a second arrangement of switches of the plurality of switches to charge the battery cell from the capacitor.

20. The solar power-assisted hybrid battery balancing system of claim 19, wherein the value of difference of the state-of-charge or voltage between the battery cell and the remaining battery cells of the plurality of battery cells is higher than a threshold difference permitted between battery cells of the plurality of battery cells.
